(19) United States
(12) Patent Application Publication
(10) Pub. No.: US 2013/0345871 A1
(43) Pub. Date: Dec. 26, 2013

(54) ROBOT CONTROLLING DEVICE, ROBOT DEVICE, ROBOT CONTROLLING METHOD, PROGRAM FOR CARRYING OUT THE ROBOT CONTROLLING METHOD AND RECORDING MEDIUM IN WHICH THE PROGRAM HAS BEEN RECORDED

(71) Applicant: CANON KABUSHIKI KAISHA, Tokyo (JP)

(72) Inventor: Akihiro Kimura, Kawasaki-shi (JP)

(21) Appl. No.: 13/914,372

(22) Filed: Jun. 10, 2013

(30) Foreign Application Priority Data
Jun. 20, 2012 (JP) 2012-138399

(51) Int. Cl. B25J 9/16

(52) U.S. Cl. CPC B25J 9/1694
USPC 700/258

(57) ABSTRACT

Provided is a robot controlling device which can accurately estimate the temperature of a frame when the drive of a robot arm main body is restarted, thereby can accurately set the distal end of the robot arm main body at a target position.

### BACKGROUND OF THE INVENTION

1. Field of the Invention

The present invention relates to a robot controlling device adapted to control a robot arm, a robot device provided with the robot controlling device, a robot controlling method, a program for carrying out the robot controlling method, and a recording medium in which the program has been recorded.

2. Description of the Related Art

Generally, a robot arm having a plurality of frames connected by joints is configured such that motors that drive the individual joints are disposed inside the frames. Each motor is provided with a temperature sensor which detects the temperature of the motor to protect the motor from overheating.

Thus, a motor is a heat generating element, so that continuing to drive a robot arm main body, which incorporates motors, causes the frames to thermally expand due to the heat generated by the motors. This has caused the distal end of the robot arm main body to be displaced in some cases.

Conventionally, therefore, the current temperatures of the frames have been estimated on the basis of the detected temperatures of the temperature sensors provided on the motors and the previous estimated temperatures of the frames, and then, based on the current estimated temperatures of the frames and the thermal expansion coefficients of the frames, the positional displacement of the distal end of the robot arm main body has been calculated. Thus, the rotational position of each motor has been controlled to cancel the displacement amount relative to a target position of the distal end of the robot arm main body (refer to Japanese Patent Application Laid-Open No. 2009-297829).

In general, however, when the drive of the robot arm main body is stopped, i.e., when the power is turned off, the execution of a program in the robot controlling device is stopped and the temperatures of the frames are not calculated while the drive of the robot arm main body is stopped.

Hence, according to the conventional configuration, while the drive of the robot arm main body is stopped, the temperature histories of the frames during the halt of the drive are unknown. This has made it impossible to accurately estimate the temperatures of the frames at a restart of the drive of the robot arm main body. Hitherto, therefore, in order to accurately estimate the temperatures of the frames of the robot arm main body, it has been necessary to wait for the drive of the robot arm main body to resume until the temperature of each frame converges to an ambient temperature. Improvement of this limitation has been desired.

### SUMMARY OF THE INVENTION

An object of the present invention is to accurately estimate the temperature of a frame when the drive of a robot arm main body is restarted so as to accurately set the distal end of the robot arm main body at a target position.

The present invention provides a robot controlling device adapted to control a robot arm which has a robot arm main body which having a joint, an actuator which is provided inside a frame of the robot arm main body and which drives the joint, and a temperature sensor which detects the temperature of the actuator, the robot controlling device including: a drive controlling unit which controls the drive of the actuator on the basis of a input drive command; and a calculating unit which estimates, at predetermined time intervals, a current estimated temperature of the frame on the basis of a thermal property of the frame, a temperature detection result obtained by the temperature sensor and a previous estimated temperature of the frame while the robot arm main body is being driven, estimates an estimated position of a distal end of the robot arm main body from the current estimated temperature of the frame, and calculates the drive command on the basis of the displacement amount of the estimated position relative to a target position of the distal end of the robot arm main body, wherein, when the drive of the robot arm main body is restarted, the calculating unit estimates a previous estimated temperature of the frame on the basis of the thermal property of the frame, the drive halt time during which the drive of the robot arm main body has been stopped, and an estimated temperature of the frame determined immediately before the drive of the robot arm main body is stopped.

Further, a robot controlling method according to the present invention adapted to control a robot arm, which has a robot arm main body having a joint, an actuator which is provided inside a frame of the robot arm main body and which drives the joint, and a temperature sensor which detects the temperature of the actuator, by using a robot controlling unit having a drive controlling unit which controls the drive of the actuator on the basis of an input drive command and a calculating unit which outputs the drive command to the drive controlling unit, the robot controlling method including: a temperature estimation step in which the calculating unit estimates, at predetermined time intervals, a current estimated temperature of the frame on the basis of the thermal property of the frame, a temperature detection result obtained by the temperature sensor and a previous estimated temperature of the frame while the robot arm main body is being driven; a displacement amount calculation step in which the calculating unit estimates the position of a distal end of the robot arm main body from a current estimated temperature of the frame and calculates the amount of displacement of an estimated position from a target position of the distal end of the robot arm main body; a drive command calculation step in which the calculating unit calculates the drive command on the basis of the amount of displacement; and a drive restart temperature estimation step in which, when the drive of the robot arm main body is restarted after the drive of the robot arm main body is stopped, the calculating unit estimates a previous estimated temperature of the frame on the basis of the thermal property of the frame, the drive halt time during which the drive of the robot arm main body has been stopped, and an estimated temperature of the frame obtained immediately before the drive of the robot arm main body is stopped.

Further features of the present invention will become apparent from the following description of exemplary embodiments with reference to the attached drawings.

### BRIEF DESCRIPTION OF THE DRAWINGS

FIG. 1 is an explanatory drawing illustrating the schematic configuration of a robot device according to an embodiment of the present invention.

FIG. 2 is a block diagram illustrating the configuration of the robot controlling device according to the embodiment of the present invention.

FIG. 3 is a functional block diagram illustrating the functions of the robot controlling device according to the embodiment of the present invention.

FIG. 4 is a flowchart illustrating the control operation of a CPU of the robot controlling device according to the embodiment of the present invention.

FIG. 5 is a diagram illustrating temperature changes in motor temperatures, frame temperatures and an ambient temperature when the drive of a robot arm main body is stopped and when the drive thereof is restarted.

FIG. 6 is a diagram illustrating the temperature changes in the motor temperatures, the frame temperatures and the ambient temperature while the robot arm main body is being driven.

### DESCRIPTION OF THE EMBODIMENTS

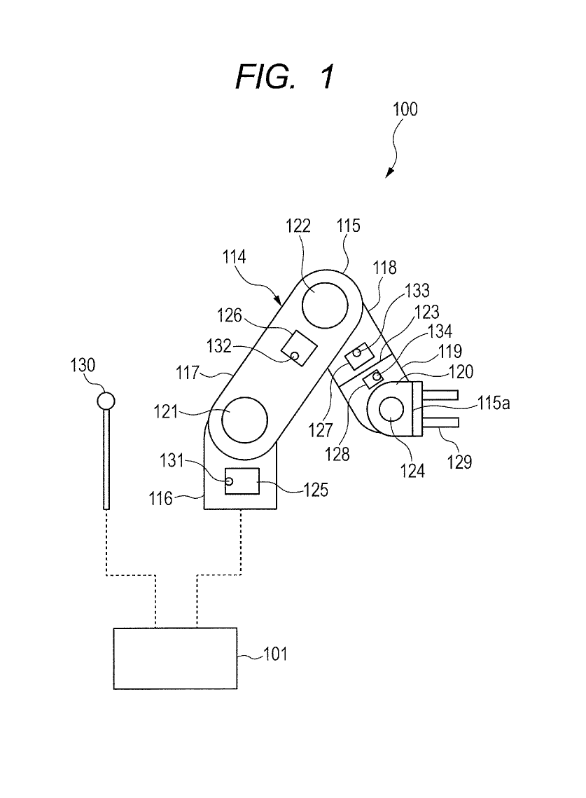

Preferred embodiments of the present invention will now be described in detail in accordance with the accompanying drawings. FIG. 1 is an explanatory drawing illustrating the schematic configuration of a robot device according to an embodiment of the present invention. A robot device 100 includes a robot arm 114, which has a multi-joint robot arm main body 115, and a robot hand 129 serving as an end effector provided at a distal end 115a of the robot arm main body 115. The robot device 100 further includes a robot controlling device 101, which controls the robot arm 114 and the robot hand 129.

The robot arm 114 has a plurality of frames 116 to 120 connected by joints 121 to 124 and electric motors (hereinafter referred to as “the motors”) 125 to 128 functioning as a plurality of actuators that drive the joints 121 to 124.

Specifically, the second frame 117 is rotatively or swingably connected at the first joint 121 with respect to the first frame 116, and the third frame 118 is rotatively or swingably connected at the second joint 122 with respect to the second frame 117. Further, the fourth frame 119 is rotatively connected at the third joint 123 with respect to the third frame 118, and the fifth frame 120 is rotatively or swingably connected at the fourth joint 124 with respect to the fourth frame 119.

The first motor 125, which drives the first joint 121, is disposed inside the first frame 116, and the second motor 126, which drives the second joint 122, is disposed inside the second frame 117. Further, the third motor 127, which drives the third joint 123, is disposed inside the third frame 118, and the fourth motor 128, which drives the fourth joint 124, is disposed inside the fourth frame 119.

Further, the motors 125 to 128 individually incorporate therein temperature sensors 131 to 134, such as thermocouples, resistance temperature detectors, or thermistors, to detect the temperatures of the motors 125 to 128.

The robot hand 129 working as an end effector is installed to the distal end of the fifth frame 120 to impart direct effect to a workpiece (not shown), such as holding the workpiece. Provided around the robot arm main body 115 of the robot arm 114 is a temperature sensor 130, such as a thermocouple, a resistance temperature detector or a thermistor, to detect the ambient temperature of the robot arm main body 115.

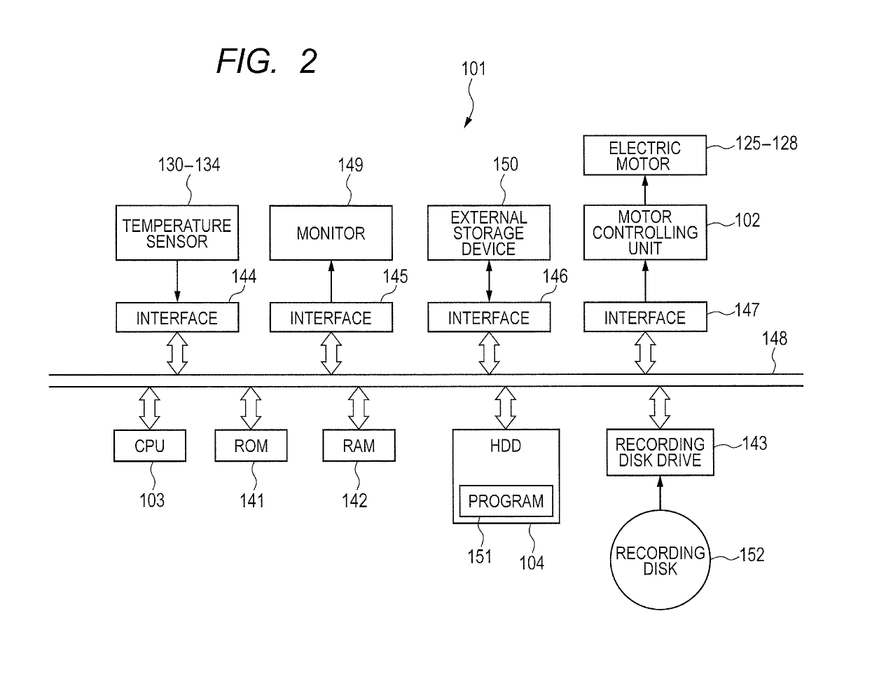

FIG. 2 is a block diagram illustrating the configuration of a robot controlling device according to an embodiment of the present invention. A robot controlling device 101 includes a CPU 103 constituting a calculating unit, a ROM 141, a RAM 142, an HDD 104 constituting a storing unit, a recording disk drive 143 and various interfaces 144 to 147. The robot controlling device 101 further has a motor controlling unit 102 serving as a drive controlling unit that controls the drive of a plurality of motors 125 to 128.

Connected to the CPU 103 through a bus 148 are the ROM 141, the RAM 142, the HDD 104, the recording disk drive 143 and the various interfaces 144 to 147. A basic program, such as BIOS, is stored in the ROM 141. The RAM 142 is a memory device for temporarily storing arithmetic processing results of the CPU 103.

The HDD 104 is a storing unit for storing various types of data, which is the arithmetic processing results of the CPU 103, and the HDD 104 also records a program 151 for causing the CPU 103 to carry out various types of arithmetic processing. The CPU 103 carries out various types of arithmetic processing according to the program 151 recorded or stored in the HDD 104.

The temperature sensors 130 to 134 are connected to the interface 144. The CPU 103 receives the inputs of temperature detection results, i.e., temperature data, from the temperature sensors 130 to 134 through the interface 144 and the bus 148.

The motor controlling unit 102 is connected to the interface 147. The CPU 103 outputs, at predetermined time intervals, the data on individual drive commands indicating the control amounts of the rotational angles of the motors 125 to 128 to the motor controlling unit 102 through the bus 148 and the interface 147. The motor controlling unit 102 calculates the output amount of the current to be supplied to each of the motors 125 to 128 on the basis of each of the drive commands input from the CPU 103 serving as the calculating unit, and supplies the current to each of the motors 125 to 128, thereby controlling the position of the distal end 115a of the robot arm main body 115. The drive commands are current commands indicating the values of currents to be output to the motors 125 to 128.

A monitor 149 is connected to the interface 145. The monitor 149 displays various images. The interface 146 is configured to permit connection of an external storage device 150, such as a rewritable nonvolatile memory or an external HDD. The recording disk drive 143 is capable of reading a program or the like recorded in the recording disk 152.

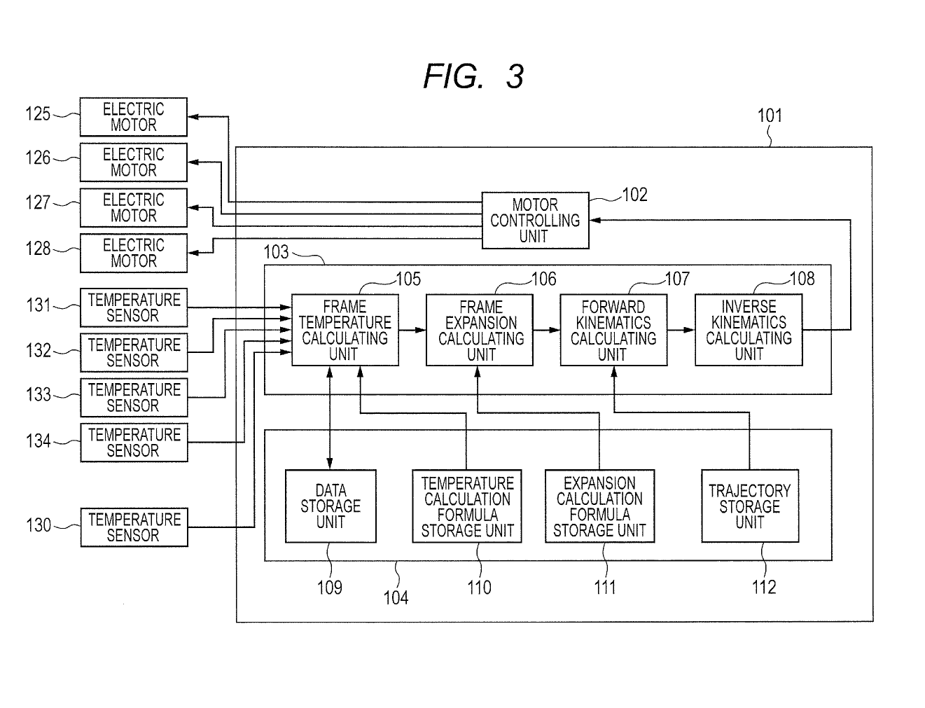

FIG. 3 is a functional block diagram illustrating the functions of the robot controlling device according to an embodiment of the present invention. In the present embodiment, the CPU 103 serving as the calculating unit reads the program 151 (FIG. 2) from the HDD 104 and carries out the program 151 when an operator turns the power on or when other start operation is performed. Then, the CPU 103 functions as a frame temperature calculating unit 105, a frame expansion calculating unit 106, a forward kinematics calculating unit 107 and an inverse kinematics calculating unit 108 by carrying out the program 151. The CPU 103 stops carrying out the program 151 when the operator performs an operation, including the turning off of the power, or in case of an emergency stop.

The HDD 104 serving as a storing unit has a data storing unit 109, a temperature calculation formula storing unit 110, an expansion calculation formula storing unit 111, and a trajectory storing unit 112, which indicate storage areas that are different from each other. Although the HDD 104 according to the present embodiment has the storing units 109 to 112, the storage medium is not limited to the HDD 104 and may be any storage medium as long as it is a rewritable nonvolatile storage medium in which data is not erased when the power is turned off. Further, the number of the storage media may be more than one rather than being limited to one.

The frame temperature calculating unit 105 estimates, by calculation at predetermined time intervals, the current estimated temperatures of the frames 116 to 119 on the basis of the temperature detection results obtained by the temperature sensors 130 to 134 and the previous estimated temperatures of the frames 116 to 119 while the robot arm main body 115 is being driven. In this case, “the current estimated temperature” means “the present estimated temperature” and “the previous estimated temperature” means a temperature estimated a predetermined time interval before with respect to “the current estimated temperature.” Alternatively, the frame temperature calculating unit 105 may obtain the estimated temperatures of the frames 116 to 119 on the basis of the temperature detection results supplied by the temperature sensors 130 to 134. The frame temperature calculating unit 105 obtains the estimated temperatures of the frames 116 to 119 that include therein the motors 125 to 128, which are heating elements, among the plurality of the frames 116 to 120.

The estimated temperatures of the frames 116 to 119 calculated by the frame temperature calculating unit 105 are stored in the data storing unit 109. The times which are associated with the estimated temperatures and which indicate the times when the processing for calculating the estimated temperatures started are also stored in the data storing unit 109. Further, the data storing unit 109 also stores the ambient temperatures which are detected by the temperature sensor 130 and which are used when the estimated temperatures are determined. In other words, the estimated temperatures, the ambient temperatures and the times are stored as data in the data storing unit 109.

The data storing unit 109 preferably stores the data such that the data is overwritten each time the estimated temperature of each of the frames 116 to 119 is calculated. Alternatively, however, the data may be sequentially stored. In any case, while the robot arm main body 115 is being driven, the frame temperature calculating unit 105 reads out the latest estimated temperatures of the frames 116 to 119 stored in the data storing unit 109 as the previous estimated temperatures used when the current estimated temperatures of the frames 116 to 119 are determined.

The temperature calculation formula storing unit 110 stores calculation formulas used to estimate the temperatures of the frames 116 to 119. More specifically, the frame temperature calculating unit 105 uses the calculation formulas stored in the temperature calculation formula storing unit 110 to calculate the estimated temperatures of the frames 116 to 119.

The expansion calculation formula storing unit 111 stores calculation formulas for calculating the expansion amounts of the frames 116 to 119. The frame expansion calculating unit 106 acquires the current estimated temperatures of the frames 116 to 119 from the frame temperature calculating unit 105, and estimates by calculation the expansion amounts of the frames 116 to 119 according to the calculation formulas stored in the expansion calculation formula storing unit 111.

The trajectory storing unit 112 stores a target trajectory of the robot arm main body 115, i.e., the target position of the distal end 115a of the robot arm main body 115.

The forward kinematics calculating unit 107 calculates the estimated position of the distal end 115a of the robot arm main body 115 from the expansion amount of each of the frames 116 to 119 by using forward kinematics, and calculates the positional displacement amount, which is the difference between a target position read from the trajectory storing unit 112 and the estimated position. Then, based on the displacement amount, a drive command to be output to the motor controlling unit 102 is calculated.

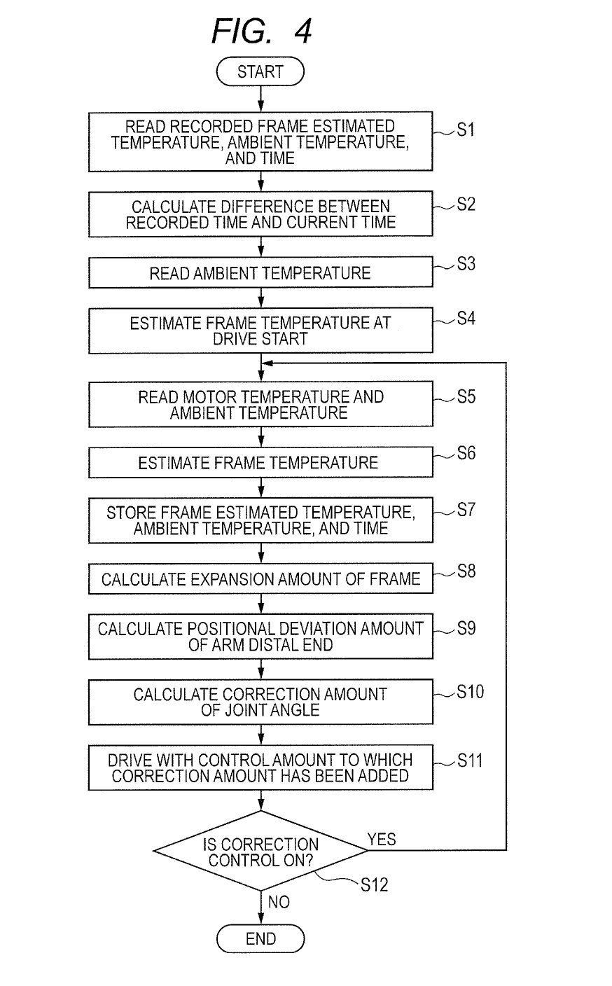

FIG. 4 is a flowchart illustrating the control operation of the CPU of a robot controlling device according to the embodiment of the present invention. The following will describe in detail the operation of a robot controlling device 101 with reference to the flowchart shown in FIG. 4.

Upon a restart of the drive of the robot arm main body 115, the frame temperature calculating unit 105 reads the data on the estimated temperatures of the frames 116 to 119, the ambient temperatures, and the times stored in the data storing unit 109 (S1). The data read from the data storing unit 109 in this case includes the estimated temperatures of the frames 116 to 119 immediately before the drive of the robot arm main body 115 was stopped, the times at which the estimated temperatures were obtained, and the ambient temperatures used when the estimated temperatures were calculated.

The restart of the drive of the robot arm main body 115 means the restart of the execution of the program 151 by the CPU 103 of the robot controlling device 101 (setting a state in which the arithmetic processing of a drive command is enabled). In other words, the time at which the drive is restarted is the time at which the CPU 103 restarts the arithmetic processing according to the program 151. Further, stopping the drive of the robot arm main body 115 means that the CPU 103 stops carrying out the program 151. In other words, the time at which the drive is stopped means the time at which the CPU 103 stops carrying out the arithmetic processing according to the program 151.

Subsequently, the frame temperature calculating unit 105 calculates the elapsed time (the drive halt time), which is the difference between the current time, i.e., the time when the drive of the robot arm main body 115 is restarted, and the time read from the data storing unit 109 (S2). In other words, in this step S2, the frame temperature calculating unit 105 calculates the difference between the read time and the current time so as to estimate the time elapsed from a stop to a restart of the calculation of the temperatures of the frames 116 to 119.

Further, the frame temperature calculating unit 105 reads the ambient temperature from the temperature sensor 130 at the current time, i.e., the time when the drive of the robot arm main body 115 is restarted (S3).

Next, the frame temperature calculating unit 105 reads expression (1) to expression (4) given below from the temperature calculation formula storing unit 110. Then, the frame temperature calculating unit 105 calculates, from the data read from the data storing unit 109, the estimated temperatures of the frames 116 to 119 at the time when the drive of the robot arm main body 115 is restarted according to expression (1) to expression (4) (S4: drive restart temperature estimation step).

α₁ₛ=A₁·α₁ₑ·exp(−Δt/B₁)+(1−A₁)·α₁ₑ·exp(−Δt/C₁)+Δα_{R} (1)

α₂ₛ=A₂·α₂ₑ·exp(−Δt/B₂)+(1−A₂)·α₂ₑ·exp(−Δt/C₂)+Δα_{R} (2)

α₃ₛ=A₃·α₃ₑ·exp(−Δt/B₃)+(1−A₃)·α₃ₑ·exp(−Δt/C₃)+Δα_{R} (3)

α₄ₛ=A₄·α₄ₑ·exp(−Δt/B₄)+(1−A₄)·α₄ₑ·exp(−Δt/C₄)+Δα_{R} (4)

Expression (1), expression (2), expression (3) and expression (4) are calculation formulas for calculating the estimated temperatures of the first frame 116, the second frame 117, the third frame 118, and the fourth frame 119, respectively, when the drive of the robot arm main body 115 is restarted.

αᵢₛ (i=1, 2, 3 or 4) denotes the estimated temperature of the frame 116, 117, 118 or 119 when the drive of the robot arm main body 115 is restarted, and provides the previous estimated temperature of the frame 116, 117, 118 or 119, which will be used for the subsequent calculation.

αᵢₑ (i=1, 2, 3 or 4) denotes the estimated temperature of the frame 116, 117, 118 or 119 immediately before the drive of the robot arm main body 115 is stopped, which estimated temperature has been read in step S1. Δt denotes the drive halt time (elapsed time) calculated in step S2. Δα_{R} denotes a change in the current ambient temperature (the ambient temperature when the drive of the robot arm main body 115 is restarted), which has been read from the temperature sensor 130 in step S3, with respect to the ambient temperature read from the data storing unit 109 in step S1.

Further, Aᵢ, Bᵢ and Cᵢ (i=1, 2, 3 or 4) are coefficients indicating the characteristics of heat radiation from the frames 116 to 119 to the atmosphere and the characteristics of heat transmission from the motors 125 to 128 to the frames 116 to 119. These coefficients Aᵢ, Bᵢ and Cᵢ are determined by measuring beforehand the characteristics of the first frame 116 to the fourth frame 119.

More specifically, the frame temperature calculating unit 105 estimates in step S4 the estimated temperature αᵢₛ of each of the frames 116 to 119 on the basis of the heat characteristics (the heat radiation characteristic and the heat transmission characteristic) of each of the frames 116 to 119, the drive halt time Δt, and the estimated temperature αᵢₑ of each of the frames 116 to 119.

The following will describe in detail an example of the method for estimating the temperature of the first frame 116 when the drive of the robot arm main body 115 is restarted.

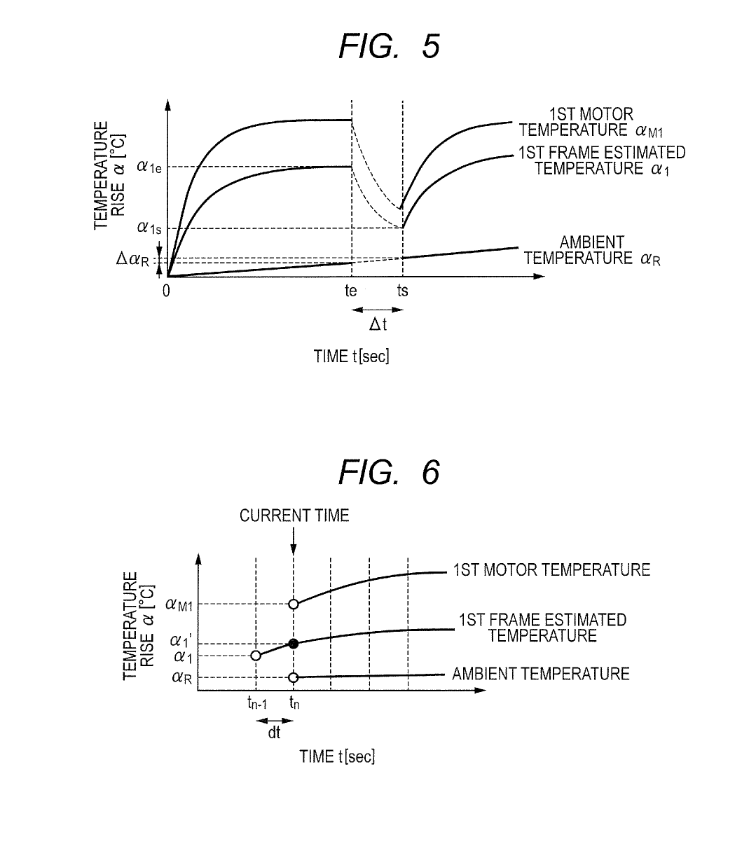

FIG. 5 is a diagram illustrating the temperature changes in the motor temperature, the frame temperature and the ambient temperature when the drive of the robot arm main body 115 is stopped and when the drive thereof is restarted. Referring to FIG. 5, t denotes time, tₑ denotes the time when the drive of the robot arm main body 115 is stopped (when the power is turned off), and tₛ denotes the time when the drive of the robot arm main body 115 is restarted. Further, α denotes a temperature rise, α₁ₑ denotes the estimated temperature of the first frame 116 immediately before the drive of the robot arm main body 115 is stopped, α₁ₛ denotes the estimated temperature of the first frame 116 when the drive is restarted, α_{R} denotes the ambient temperature, and Δα_{R} denotes a change in the ambient temperature at the time when the drive is restarted with respect to the time when the drive is stopped.

In FIG. 5, the robot arm main body 115 is driven from time 0 to time tₑ, during which the temperature of the first motor 125 rises, as shown in FIG. 5. The current estimated temperature of the first frame 116 is estimated until time tₑ according to the method, which will be discussed hereinafter, on the basis of the detection temperature of the first motor 125 and the previous estimated temperature of the first frame 116.

The acquisition of the detection temperature of the first motor 125 or the calculation of the estimated temperature of the first frame 116 is not carried out during the drive halt time Δt from time tₑ when the drive of the robot arm main body 115 is stopped to time tₛ when the drive of the robot arm main body 115 is restarted. The temperature α₁ₛ of the first frame 116 at time tₛ at which the drive of the robot arm main body 115 is restarted is determined by the temperature history of the first motor 125 from time tₑ to time tₛ and the change Δα_{R} in the ambient temperature. For this reason, the temperature α₁ₛ of the first frame 116 cannot be estimated from a temperature α_{M1} of the first motor 125 when the drive of the robot arm main body 115 is restarted.

According to the present embodiment, therefore, the frame temperature calculating unit 105 substitutes the values of the estimated temperature α₁ₑ of the first frame 116, the drive halt time Δt, and the change Δα_{R} in the ambient temperature into expression (1) mentioned above thereby to estimate the estimated temperature α₁ₛ of the first frame 116. The estimated temperature α₁ₛ obtained as described above is used as the previous estimated temperature of the first frame 116 in the calculation processing in a subsequent step S6.

Subsequently, the frame temperature calculating unit 105 reads the temperatures of the motors 125 to 128 and the ambient temperature of the robot arm main body 115 from the temperature sensors 130 to 134 in a predetermined time interval from the time at which the estimated temperatures of the frames 116 to 119 were calculated last (S5).

Then, the frame temperature calculating unit 105 carries out the arithmetic processing for estimating the current (present) estimated temperatures of the frames 116 to 119 by using the calculation formulas read from the temperature calculation formula storing unit 110 (S6: temperature estimation step). The current estimated temperatures of the frames 116 to 119 which have been calculated are output to the frame expansion calculating unit 106.

In step S6, the calculation formulas read from the temperature calculation formula storing unit 110 by the frame temperature calculating unit 105 are described, for example, as follows.

α′₁=α₁+dt(D₁·α_{M1}−E₁·α₁+F₁·α_{R}) (5)

α′₂=α₂+dt(D₂·α_{M2}−E₂·α₂+F₂·α_{R}) (6)

α′₃=α₃+dt(D₃·α_{M3}−E₃·α₃+F₃·α_{R}) (7)

α′₄=α₄+dt(D₄·α_{M4}−E₄·α₄+F₄·α_{R}) (8)

Expression (5), expression (6), expression (7) and expression (8) are calculation formulas for calculating the current estimated temperatures of the first frame 116, the second frame 117, the third frame 118, and the fourth frame 119, respectively.

Expressions (5) to (8) have been derived as follows. First, if the amount of heat transmitted to the frames 116 to 119 is denoted by Qᵢₙ (J), while the amount of heat radiated to the surrounding area from the frames 116 to 119 is denoted by Qₒᵤₜ (J), then the following expression (9) and expression (10) are derived.

Qᵢₙ=k·S/x(α_{M}−α)dt (9)

Qₒᵤₜ=hS′(α−α_{R})dt (10)

In the above expressions, k denotes the thermal conductivity (W/mK), which indicates the ease of transmission of the heat from the motors 125 to 128 to the frames 116 to 119, S denotes the sectional area (m²) of heat transfer, and x denotes the distance (m) of heat transfer. Further, α_{M} denotes a temperature change (° C.) from a reference value of the motor temperature, α denotes a temperature change (° C.) from a reference value of the frame temperature, and h denotes the heat transfer coefficient (W/m²K) indicating the ease of heat radiation to the surrounding area from the frames 116 to 119. S′ denotes the surface area (m²) of heat radiation to the surrounding area from the frames 116 to 119, and dt denotes a calculation interval (predetermined time interval).

Further, the temperature rise of each of the frames 116 to 119 attributable to the difference between Qᵢₙ and Qₒᵤₜ can be represented by expression (11) given below.

Qᵢₙ−Qₒᵤₜ=cρV(α′−α) (11)

In expression (11), c denotes the specific heat (J/kgK) of each of the frames 116 to 119, ρ denotes the density (kg/m³) of each of the frames 116 to 119, and V denotes the volume (m³) of each of the frames 116 to 119. α denotes the previous estimated temperature (° C.) of each of the frames 116 to 119 and α′ denotes the current estimated temperature (° C.) of each of the frames 116 to 119.

Expressions (9), (10) and (11) are organized into expression (12) given below.

K₁(α_{M}−α)dt−K₂(α−α_{R})dt=K₃(α′−α) (12)

K₁ denotes k·S/x, K₂ denotes hS′, and K₃ denotes cρV.

Further, expression (12) can be organized into expression (13) given below.

α′=α+dt(D·α_{M}−E·α+F·α_{R}) (13)

D denotes K₁/K₃, E denotes (K₁+K₂)/K₃, and F denotes K₂/K₃. Expression (13) is provided for each of the frames 116 to 119, so that the four expressions (5) to (8) are prepared. Dᵢ, Eᵢ and Fᵢ (i=1, 2, 3 or 4) denote the coefficients determined by measuring beforehand the temperature characteristics in the frames 116 to 119.

More specifically, the frame temperature calculating unit 105 estimates in step S6 the current estimated temperature α′ᵢ of each frame on the basis of the heat characteristics of the frames 116 to 119, the temperature detection results provided by the temperature sensors 130 to 134, and the previous estimated temperature αᵢ of each frame.

The method for calculating the temperature of the first frame 116, as an example, will now be described in detail. FIG. 6 is a diagram illustrating the temperature changes in the motor temperature, the frame temperature and the ambient temperature while the robot arm main body 115 is being driven. Referring to FIG. 6, α₁ denotes the previous estimated temperature of the first frame 116 calculated at time tₙ₋₂, which is before the current time tₙ by the predetermined time interval dt. α′₁ denotes the current estimated temperature of the first frame 116 calculated at time tₙ. α_{M1} denotes the temperature of the first motor 125, and α_{R} denotes the ambient temperature.

The estimated temperature α′₁ of the first frame 116 is calculated according to expression (5) by using the estimated temperature α₁ of the first frame 116 that has been calculated last time, the current first motor temperature α_{M1} and the ambient temperature α_{R}. The calculation interval (the predetermined time interval) dt is, for example, 1 second.

By repeating the calculation at the predetermined time interval dt, the history of the motor temperature, the history of the frame temperature, and the history of the ambient temperature are integrated, as indicated by expressions (5) to (8). Therefore, even if the operation is changed and the calorific value of the motor 125, 126, 127 or 128 changes or if the ambient temperature changes while the robot arm main body 115 is being driven, the temperature of each of the frames 116 to 119 can be accurately estimated.

When the drive of the robot arm main body 115 is restarted, the previous estimated temperature used to determine the current estimated temperature of each of the frames 116 to 119 in step S6 is determined by the processing in steps S1 to S4.

Subsequently, the frame temperature calculating unit 105 transmits the obtained estimated temperature of each of the frames 116 to 119, the time at which each of the estimated temperatures was obtained, and the ambient temperature used to calculate each of the estimated temperatures to the data storing unit 109 so as to store the data in the data storing unit 109 (S7).

Further, the frame temperature calculating unit 105 sends the data on the obtained current estimated temperatures of the frames 116 to 119 to the frame expansion calculating unit 106.

The frame expansion calculating unit 106 reads the calculation formulas of expressions (14) to (17) given below from the expansion calculation formula storing unit 111, and calculates the expansion amount of each of the frames 116 to 119 according to the calculation formulas of expressions (14) to (17) from the current estimated temperature of each of the frames 116 to 119 (S8).

ΔL₁=α′₁×δhd 1×L₁ (14)

ΔL₂=α′₂×δhd 2×L₂ (15)

ΔL₃=α′₃×δhd 3×L₃ (16)

ΔL₄=α′₄×δhd 4×L₄ (17)

Expressions (14), (15), (16), and (17) are calculation formulas for calculating the expansion amounts of the first frame, the second frame, the third frame, and the fourth frame, respectively. In other words, these calculation formulas include the information on the expansion rates and the lengths of the frames 116 to 119.

In this case, δᵢ (i=1, 2, 3 or 4) denotes the coefficient of expansion of each frame material. For example, the coefficient of expansion of typical aluminum is 24×10⁻⁶/° C. If the frames 116 to 119 are composed of a plurality of materials, then the coefficient of expansion δᵢ used here may use the mean value thereof.

Further, Lᵢ (i=1, 2, 3 or 4) denotes the length of each of the frames 116 to 119, specifically, for example, the axis-to-axis distance. The length Lᵢ of each of the frames 116 to 119 denotes the length for calculating the amount of expansion ΔLᵢ caused by heat. Hence, if there is a portion that does not contribute to the thermal expansion, then the length of the portion may be excluded.

The frame expansion calculating unit 106 sends the calculated amounts of expansion of the frames 116 to 119 to the forward kinematics calculating unit 107.

The forward kinematics calculating unit 107 calculates the estimated position of the distal end 115a of the robot arm main body 115 by using the data on the amounts of expansion of the frames 116 to 119 attributable to heat by forward kinematics calculation. Then, the forward kinematics calculating unit 107 reads the target position of the distal end 115a of the robot arm main body 115 from the trajectory storing unit 112, and calculates the amount of displacement of the estimated position from the read target position (S9: displacement amount calculation step). The forward kinematics calculating unit 107 sends the data on the calculated displacement amount to the inverse kinematics calculating unit 108.

Subsequently, the inverse kinematics calculating unit 108 calculates the correction amount of the rotational angle of each of the joints 121 to 124 by inverse kinematics calculation from the positional displacement amount of the distal end 115a of the robot arm main body 115 (S10) and then calculates a drive command that provides a control amount on which the correction amount has been reflected (S11). In other words, the inverse kinematics calculating unit 108 calculates a drive command on the basis of the displacement amount of the distal end 115a in these steps S10 and S11 (drive command calculation step). The inverse kinematics calculating unit 108, i.e., the CPU 103, outputs the calculated drive command to the motor controlling unit 102. The motor controlling unit 102 supplies electric current to the motors 125 to 128 in response to received drive commands, thus causing the motors 125 to 128 to drive the joints 121 to 124 according to control amounts based on the drive commands.

The CPU 103 checks whether correction control is ON (S12), and if the correction controls is ON (S12: Yes), then the CPU 103 returns to the arithmetic processing in step S5 to repeat the control. If the correction control is OFF (S12: No), then the correction control is stopped. In this case, the state in which the correction control is OFF means the state in which the drive of the robot arm main body 115 is at halt, as in the case of an emergency stop or in the case where the power of the robot device 100 is turned off.

Then, when the drive of the robot arm main body 115 is restarted, the CPU 103 carries out the processing from step S1 and obtains the estimated temperatures of the frames 116 to 119 at the restart of the drive by using the data before the drive was stopped, which has been recorded in the data storing unit 109, as described above.

Thus, according to the present embodiment, after the drive of the robot arm main body 115 is stopped, even if the drive of the robot arm main body 115 is restarted before the temperatures of the frames 116 to 119 completely fall to an ambient temperature, the temperatures of the frames 116 to 119 can be accurately estimated. As a result, the distal end 115a of the robot arm main body 115 can be accurately set at a target position when the drive is restarted.

Further, the ambient temperature of the robot arm main body 115 is also used for calculating the estimated temperatures of the frames 116 to 119, so that the positional displacement of the distal end 115a can be accurately corrected even if the thermal expansions of the frames 116 to 119 change due to a change in the ambient temperature.

It is to be understood that the present invention is not limited to the embodiments described above. To the contrary, the invention can be embodied in many modifications within the technical spirit of the present invention by persons ordinarily skilled in the art.

In the aforesaid embodiments, the description has been given of the case where the robot arm 114 is a vertical multi-joint robot. However, the robot arm 114 may alternatively be a horizontal multi-joint robot, a parallel link robot or the like.

Further, in the aforesaid embodiments, the description has been given of the case where the ambient temperature changes; however, the present invention is not limited thereto. If the environment in which the robot arm 114 is placed has a constant temperature, then it is unnecessary to take a change in the ambient temperature into account when calculating the estimated temperatures of the frames 116 to 119. More specifically, +Δα_{R} may be omitted in the calculation formulas of expression (1) to expression (4).

Further, in the aforesaid embodiments, the description has been given of the case where the actuators are electric motors; however, the actuators are not limited thereto. For example, if the joints are prismatic joints, then electric linear actuators may be used, as the actuators, in place of the electric motors. In this case also, the present invention is applicable. Especially when the electric actuators are used as the actuators, much heat is generated by energization, so that the distal end of the robot arm main body can be effectively set at a target position by the present invention.

Further, in the aforesaid embodiments, the description has been given of the case where the robot arm main body has four joints; however, the number of the joints is not limited thereto. The robot arm main body may have any number of joints, provided that it has at least one joint.

Each of the processing operations of the embodiments described above is specifically carried out by the CPU 103 serving as the calculating unit of the robot controlling device 101. Therefore, the processing operations may alternatively be accomplished by supplying a recording medium in which a program for implementing the functions described above has been recorded to the robot controlling device 101 and by reading and executing the program stored in the recording medium by a computer (CPU or MPU) of the robot controlling device 101. In this case, the program itself read from the recording medium will implement the functions of the aforesaid embodiments, and the program itself and the recording medium in which the program has been recorded will constitute the present invention.

Further, in the aforesaid embodiments, the description has been given of the case where the computer-readable recording medium is the HDD 104 and the program 151 is stored in the HDD 104; however, the present invention is not limited thereto. The program 151 may be recorded in any type of recording medium, provided that it is a computer-readable recording medium. The recording medium used for supplying the program may be, for example, the ROM 141, the external storage device 150 or the recording disk 152 shown in FIG. 2. Specific examples of the recording medium that can be used include a flexible disk, a hard disk, an optical disk, a magneto-optical disk, a CD-ROM, a CD-R, a magnetic tape, a nonvolatile memory card, and a ROM.

Further, the program in the aforesaid embodiments may be downloaded through a network and executed by a computer.

The present invention is not limited to the case where the functions of the aforesaid embodiments are implemented by carrying out program codes read by a computer. The present invention also includes a case where an operating system (OS) or the like running on a computer carries out a part or all of actual processing according to the instructions of the program codes so as to implement the functions of the aforesaid embodiments by the processing.

Further, the program codes read from a recording medium may be written to a memory provided in a feature enhancement board inserted in a computer or a feature enhancement unit connected to a computer. The present invention further includes a case where a CPU or the like provided in the feature enhancement board or the feature enhancement unit carries out a part or all of the actual processing according to the instructions of the program codes so as to implement the functions of the aforesaid embodiments by the processing.

According to the present invention, even if the drive of the robot arm main body is restarted before the temperatures of the frames completely fall to an ambient temperature, the temperatures of the frames can be accurately estimated. As a result, the distal end of the robot arm main body can be accurately set at a target position when the drive is restarted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-138399, filed on Jun. 20, 2012, which is hereby incorporated by reference herein in its entirety.

What is claimed is:

1. A robot controlling device which controls a robot arm having a robot arm main body provided with a frame, an actuator which drives the robot arm main body, and a temperature sensor which detects the temperature of the actuator, comprising:
a drive controlling unit which controls the drive of the actuator on the basis of an input drive command; and
a calculating unit which estimates an estimated temperature of the frame on the basis of a temperature detection result provided by the temperature sensor, estimates an estimated position of a distal end of the robot arm main body from the estimated temperature of the frame, and calculates a drive command for the actuator on the basis of an amount of displacement of the estimated position of the distal end of the robot arm main body relative to a target position,
wherein, in the case where the drive of the robot arm main body is restarted after the drive of the robot arm main body is stopped, the calculating unit estimates an estimated temperature of the frame at the point of time, at which the drive of the robot arm main body is restarted, on the basis of a thermal property of the frame, drive halt time of the robot arm main body, and an estimated temperature of the frame obtained immediately before the drive of the robot arm main body is stopped.

2. The robot controlling device according to claim 1, wherein the calculating unit corrects the estimated temperature of the frame, which was determined when the drive of the robot arm main body was restarted, on the basis of a change in an ambient temperature of the robot arm main body, which change has occurred with the elapse of the drive halt time.

3. The robot controlling device according to claim 1, comprising a storing unit which stores the estimated temperature of the frame estimated by the calculating unit, associating the estimated temperature with time when estimated,
wherein the calculating unit calculates, as the drive halt time, a difference between time associated with the estimated temperature of the frame immediately before the drive of the robot arm main body is stopped, which has been stored in the storing unit, and time at which the drive of the robot arm main body is restarted.

4. A robot device comprising: a robot arm having a robot arm main body provided with a frame, an actuator which drives the robot arm main body, and a temperature sensor which detects the temperature of the actuator; and the robot controlling device according to claim 1.

5. A robot controlling method for controlling a robot arm, which has a robot arm main body provided with a frame, an actuator which drives the robot arm main body, and a temperature sensor which detects the temperature of the actuator, by using a robot controlling device having a drive controlling unit which controls the drive of the actuator on the basis of an input drive command and a calculating unit which outputs the drive command to the actuator, the robot controlling method comprising:
a temperature estimation step in which, in the case where the drive of the robot arm main body is restarted after the drive of the robot arm main body is stopped, the calculating unit estimates an estimated temperature of the frame at the point of time at which the drive of the robot arm main body is restarted on the basis of drive halt time of the robot arm main body, a thermal property of the frame, and an estimated temperature of the frame obtained immediately before the drive of the robot arm main body is stopped;
a displacement amount calculation step in which the calculating unit estimates the position of a distal end of the robot arm main body from the estimated temperature of the frame at the point of time at which the drive of the robot arm main body is restarted and calculates the amount of displacement of an estimated position of the distal end of the robot arm main body relative to a target position; and
a drive command calculation step in which the calculating unit calculates a drive command for the actuator on the basis of the displacement amount.

6. A program for causing a computer to carry out the steps of the robot controlling method according to claim 5.

7. A computer-readable recording medium in which the program according to claim 6 has been recorded.
